(19) United States
(12) Patent Application Publication
(10) Pub. No.: US 2010/0270108 A1
(43) Pub. Date: Oct. 28, 2010

(54) SPINDLE GREASING METHOD AND APPARATUS

(76) Inventor: Ronald E. Brunner, Sundance, WY (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/752,295

(22) Filed: Apr. 1, 2010

Related U.S. Application Data
(60) Provisional application No. 61/172,870, filed on Apr. 27, 2009.

(51) Int. Cl. B60R 17/02

(52) U.S. Cl. 184/7.2

(57) ABSTRACT

An assembly includes a spindle and a middle spacer with a sleeve section surrounding a length portion of the spindle; upper and lower bearings; and a housing including a cavity receiving the spindle with the upper and lower bearings supporting the spindle in the cavity. A grease passageway includes a first portion formed by axial and radial holes in a top end of the spindle, a second portion of longitudinal passages formed between the middle spacer and the spindle, and a third portion formed by radial dispersion channels formed between a collar on the middle spacer and the lower bearing.

This application claims benefit under 35 U.S.C. §119(e) of provisional application Ser. No. 61/172,870, filed Apr. 27, 2009, entitled SPINDLE GREASING METHOD AND APPARATUS, the entire contents of which are incorporated herein by reference.

### BACKGROUND

The present invention relates to a spindle apparatus configured for directing grease to a bearing mounted thereon. More specifically this is an apparatus and method of routing grease to a bearing(s) in a lawnmower blade spindle housing assembly, though not limited to only lawnmowers, nor to blade spindle housing assemblies.

Currently, most lawnmower blade spindle housings just have grease inserted into one or more cavities in the housing. For example, see the prior art illustrated in FIGS. 13-14. These systems depend on gravity, heat and centrifugal force to move the grease from that location into a lower bearing(s). In some applications, the grease is inserted through the top bearing with gravity taking it to the lower bearing. This design requires a significant amount of grease to be inserted into the housing in order to properly fill the cavity and cause the grease to move into the lower bearing, more than the typical consumer adds. It has been found that the grease does not always get into the lower bearing, especially if the consumer does not grease the housing adequately. This causes premature failures and increased warranty costs. The lower bearing is typically the bearing that is under the most stress and fails first. Another concern is that excess grease in the cavity is wasted and un-used when the mower is worn out and scrapped, and due to its hidden location, is typically not properly disposed of in an environmentally friendly way.

### SUMMARY OF THE PRESENT INVENTION

In one aspect of the present invention, an assembly includes a spindle and a bearing spacer with a sleeve section surrounding a length portion of the spindle; upper and lower bearings; a housing including a cavity receiving the spindle with the upper and lower bearings supporting the spindle in the cavity; and a narrow grease passageway extending from an end of the spindle to at least the lower bearing.

In another aspect of the present invention, a spindle assembly having a length and adapted to convey grease along at least part of the length, comprises a spindle having an axial hole in one end and at least one radial hole extending from an end of the axial hole to an outer surface of the spindle, and a bearing spacer with a sleeve component surrounding a portion of the spindle; at least one of the spindle and the sleeve component defining at least one longitudinal grease passageway extending from the least one radial hole and extending a distance along the spindle.

In another aspect of the present invention, a spindle assembly including a blade-shielding deck and a rotatable blade, the housing being attached to the deck by fasteners, the blade being attached to the spindle.

In another aspect of the present invention, a spindle assembly having a length and adapted to convey grease along at least part of the length, comprising a spindle and a bearing spacer with a sleeve component surrounding a length portion of the spindle, the spindle and the sleeve component combining to define opposing sides of at least one grease passageway extending a longitudinal distance along the spindle.

In another aspect of the present invention, an assembly includes a spindle, at least a lower bearing, a housing including a cavity receiving the spindle with the lower bearing supporting the spindle in the cavity, and a grease-passageway-defining member on the spindle and in the cavity, the spindle including a top end with at least one hole extending to the grease-passageway-defining member, the spindle and the grease-passageway-defining member combining to define a continuous narrow passageway extending from the top end to the lower bearing for communicating grease directly thereto from the top end.

In another aspect of the present invention, a method comprises steps of providing an assembly including a spindle, a bearing spacer with a sleeve section surrounding a length portion of the spindle, upper and lower bearings, and a housing having a cavity receiving the spindle with the upper and lower bearings supporting the spindle in the cavity, and passing grease into a top end of the spindle, and then to at least one longitudinally-extending grease passageway formed at least in part by portions of the spindle and the bearing spacer, and then radially to the lower bearing.

These and other aspects, objects, and features of the present invention will be understood and appreciated by those skilled in the art upon studying the following specification, claims, and appended drawings.

### BRIEF DESCRIPTION OF DRAWINGS

FIG. 1 is a longitudinal cross-sectional view taken along an assembly including the present spindle assembly, a top-mounted pulley, and a bottom-mounted blade.

FIG. 1A is an exploded view of the spindle assembly of FIG. 1.

FIG. 2 is longitudinal cross-sectional view of the spindle assembly.

FIGS. 3-6 are perspective, side, top, and bottom views of the spindle of FIG. 2.

FIGS. 7-9 are cross-sectional views taken along lines VII, VIII, and IX in FIG. 4.

FIG. 10 is an enlarged fragmentary view of the circled area in FIG. 3.

FIGS. 11-12 are side and bottom views of the middle spacer shown in FIG. 1A spacer positioned on the shaft of the spindle in FIG. 1.

FIGS. 13 and 14 are side cross-sectional views of prior art spindle assemblies.

### DETAILED DESCRIPTION OF PREFERRED EMBODIMENTS

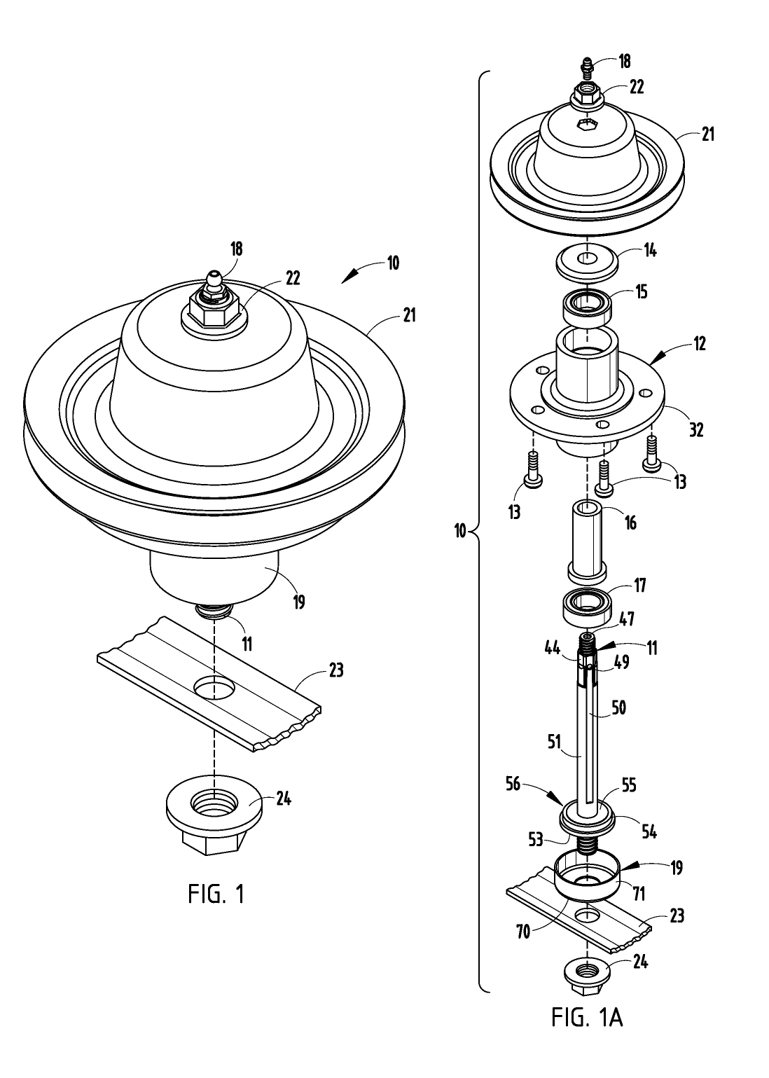

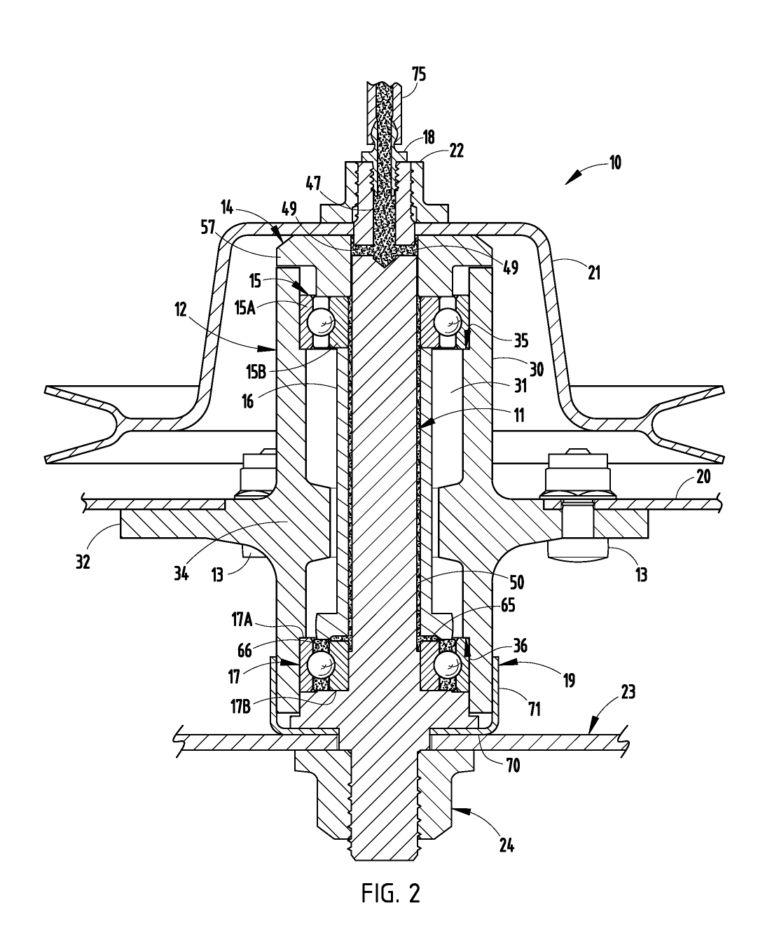

The present apparatus 10 (also called an “assembly”) (FIG. 1A) includes a spindle 11, a housing 12, a plurality of round head knurled mounting studs 13, a top spacer 14, a top bearing 15, a sleeve-like middle spacer 16 (also called “sleeve component”), a bottom bearing 17, a grease input zerk 18, and a dust cup 19. The spindle 11, top spacer 14 and middle spacer 16 combine to form a defined narrow grease passageway from the grease input zerk 18 at an axial top end of the spindle 11 to the bottom bearing 17. The apparatus 10 includes fastening to a main support (such as a lawn mower deck 20 (FIG. 2)) using studs 13, and is configured to support a top pulley 21 held in position by a top compression nut 22 and a bottom lawn-mower blade 23 held by a bottom hex flange compression nut 24.

The housing 12 (FIG. 2) includes a tubular section 30 defining a cavity 31, and an attachment flange 32 located generally in its middle region. Additional material/mass 34 is provided in the tubular section adjacent the attachment flange on the inside and outside as illustrated to support the attachment flange for strength and integrity. The plurality of the attachment studs 13 are extended through the flange for securing the flange to a structural component, such as to a top wall in a mower housing/deck 20. The tubular section 30 includes an interior upper shoulder 35 for supporting an outer race 15A of the top bearing 15, and further includes an interior lower shoulder 36 for supporting an outer race 17A of the bottom bearing 17.

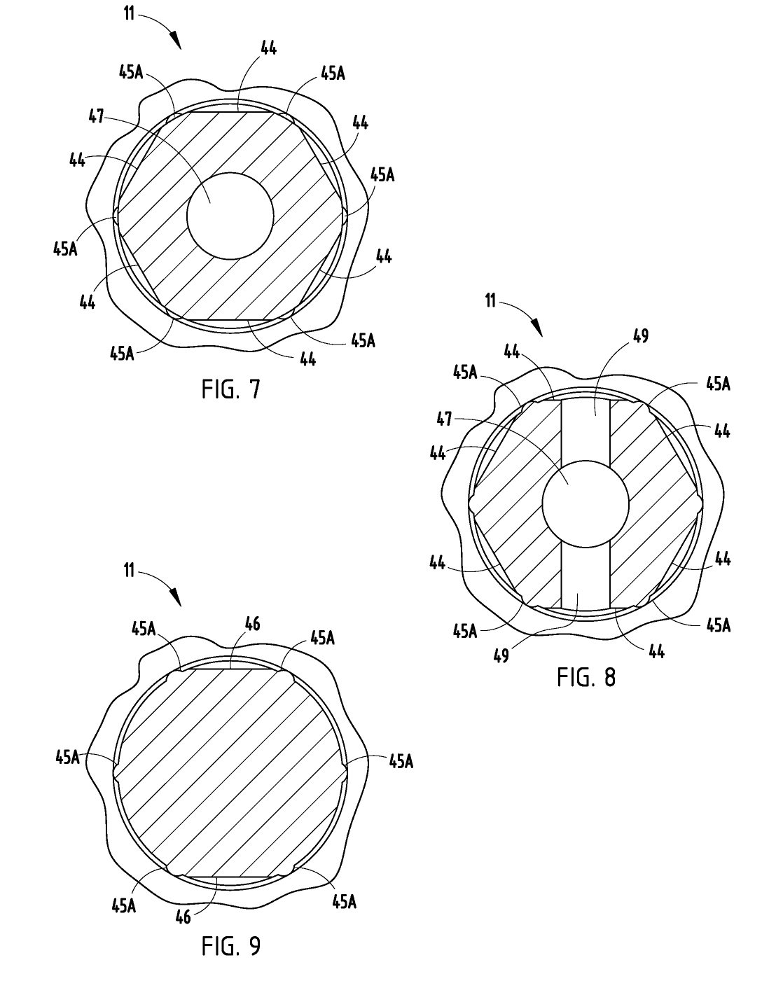

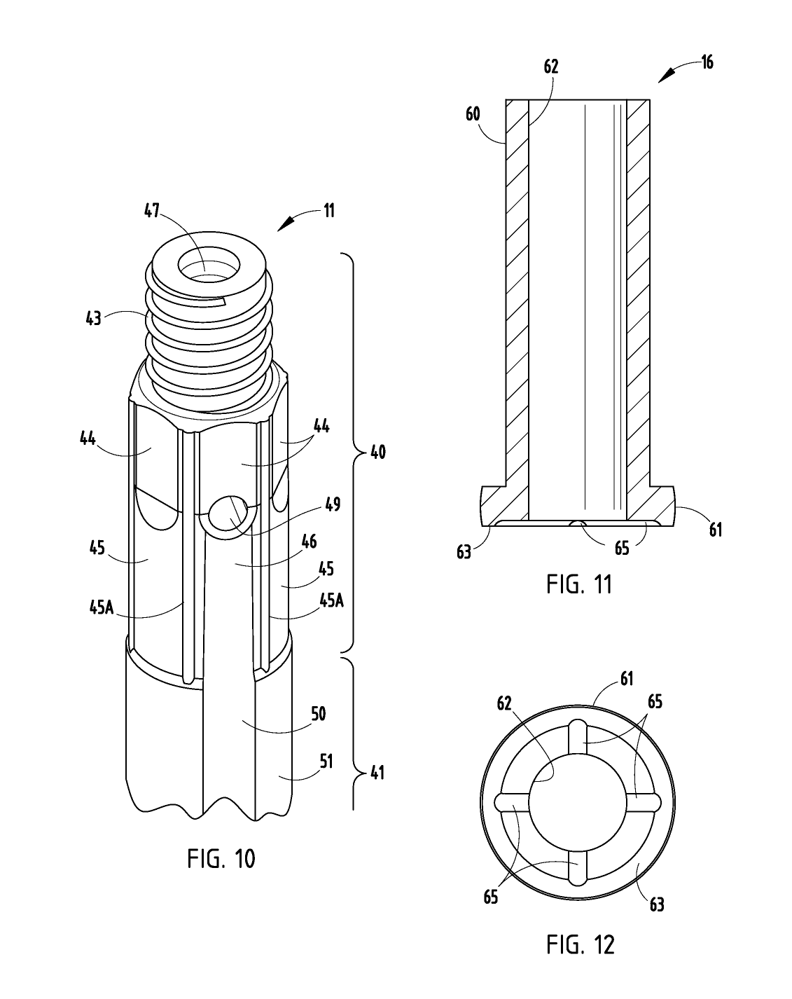

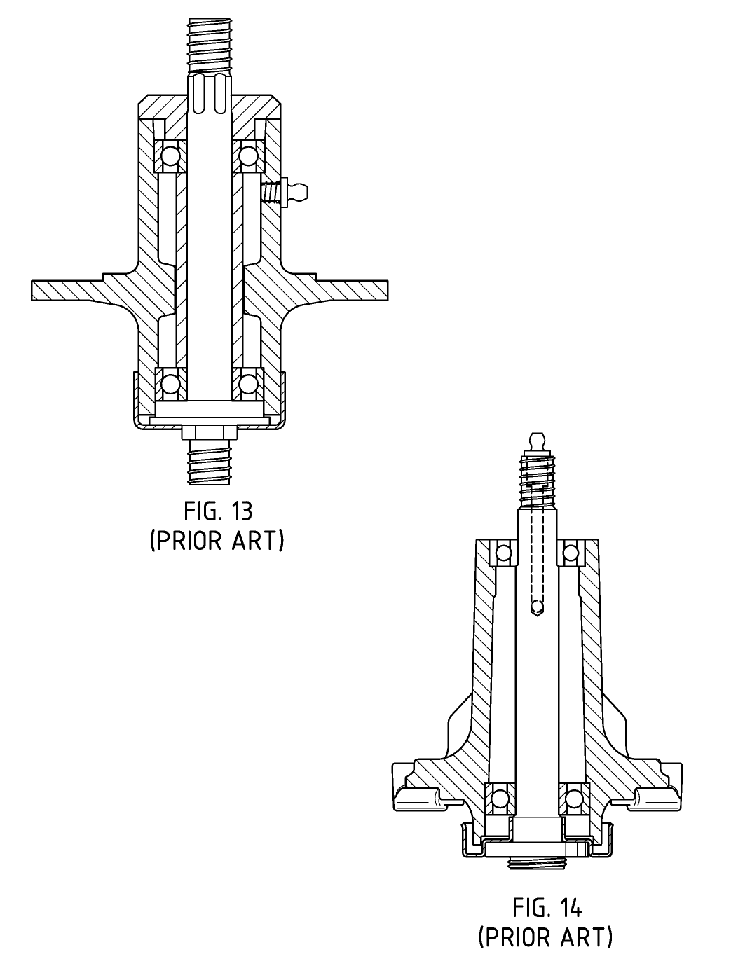

Spindle 11 (FIG. 4) includes a top end configured section 40, a middle section 41, and a bottom end configured section 42. The top end configured section (FIGS. 7-10) includes a first outer surface with threads 43, and a second outer surface with flats 44 defining a hex shape on a cylinder for keyed engagement with the pulley 21, and a third cylinder outer surface 45 with six outwardly-protruding longitudinally-extending friction ribs 45A three on each side of two flats 46. An axial hole 47 includes threads or press in zerk for receiving the grease-input zerk 18. A radial hole 49 extends through the spindle 11 at a lower end of the axial hole 47, thus forming two radial grease dispersion channels.

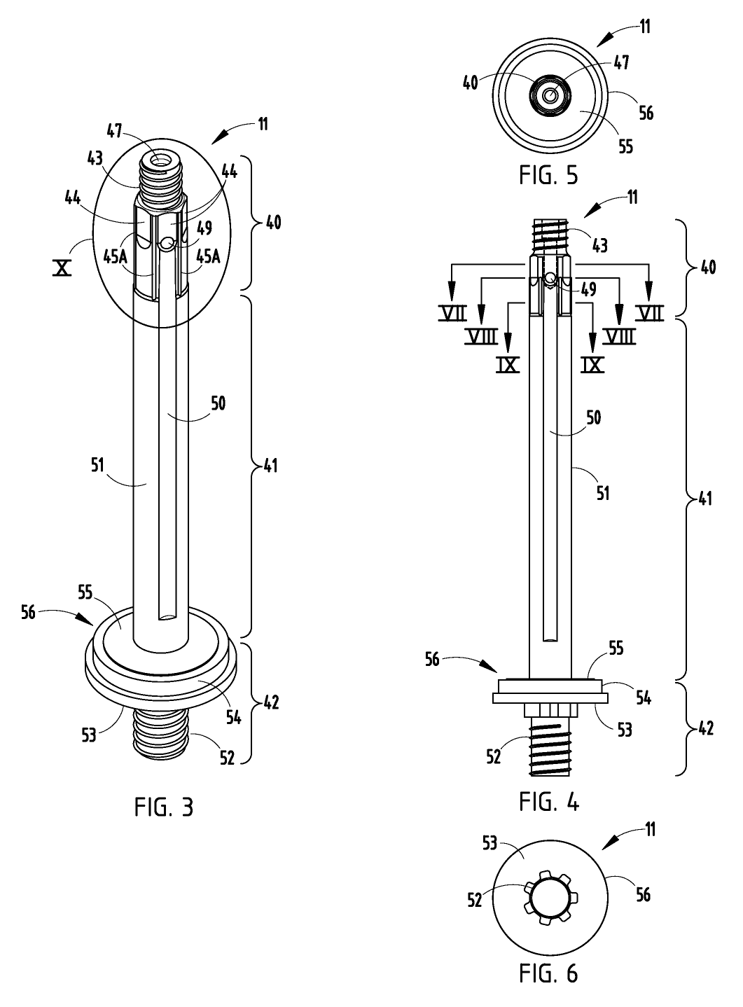

The middle section 41 (FIGS. 3-4) of the spindle 11 includes opposing longitudinally-extending flats 50 (two flats shown) formed on a cylindrically shaped circumferential surface 51. These flats 50 are aligned with and a continuation of flats 46. The radial hole 49 includes opposite ends that connect to the upper end of the longitudinally-extending flats 50.

The bottom end (FIG. 4) configured section 42 of the spindle 11 includes an outer surface with threads 52, a polygon-shaped blade-engaging portion, and a collar 56. The collar 56 has a top abutting the inner race 17B of lower bearing 17 (FIG. 2) and a bottom surface 53 for abuttingly engaging the dust cup 19. A top 55 of the collar includes a surface supporting the inner race of the bottom bearing. Another lip 54 on the collar lays adjacent the bottom of housing. The blade 23 is held on the spindle 11 by a compression nut 24 that engages the thread 52.

The top spacer 14 (FIG. 2) engages the spindle with a top section 57 covering a top of the housing cavity. An inner surface of the top spacer extends onto the hex-shape. A top surface of the top spacer supports the pulley 21. A down-protruding section of the top spacer 14 abuts an inner race of the top bearing 15. The top spacer 14 combines with the spindle 11 to define narrow grease passageways 46 that extend from the ends of radial holes 49 downward under the inner race of the top bearing 15.

The illustrated top spacer 14 does not include any radial channels, since the top bearing 15 is a sealed bearing. However, it is contemplated that if desired, the top spacer 14 could include channels similar to the lower end of the middle spacer 16, for supplying grease to an (unsealed) top bearing as discussed below. The top bearing 15 includes an outer race 15A supported on the housing 12, an inner race 15B supported on the spindle 11, and roller bearings therebetween.

The middle spacer 16 (FIGS. 2, 11, 12) includes a sleeve section 60 and a bottom collar section 61. The sleeve section 60 includes a cylindrically-shaped bore 62 forming a circular surface that closely engages a cylindrical circumferential surface of the spindle 11. As a result, the middle spacer 16 defines with the flats 50 of the spindle 11 a pair of longitudinally-extending grease paths on opposite sides of the spindle 11. The bottom collar section 61 of the spacer forms an annular ring that extends radially with a bottom surface 63 that extends at least about to a gap formed between the inner and outer races 17A, 17B of the bottom bearing 17. The bottom surface 63 (FIG. 12) of the bottom collar section 61 defines multiple radial grease-dispersion channels 65 (four shown) with a top of the inner race of the bottom bearing 17B. Since the grease-dispersion channels 65 are connected to the longitudinally-extending grease paths, they communicate grease to the bottom bearing 17.

The bottom bearing 17 (FIG. 2) is unsealed at spacer 63 surface, and includes inner and outer races 17A, 17B defining an access gap 66 for grease input to the roller bearings from the radial grease-dispersion channels.

The dust cup 19 (FIG. 2) fits onto the spindle 11, with its bottom wall 70 abutting the collar section of the spindle, and with its side walls 71 overlapping onto the bottom of the housing 12. The blade 23 is attached to the bottom of the spindle 11 by the top of the compression nut 24, which secures the dust cup 19 in place. The cup 19 spins with the spindle 11 during operation.

The top pulley 21 (FIG. 2) is assembled onto the spindle 11 using the compression nut 22. The combination of the pulley 21 and top spacer 14 helps prevent grease from exiting undesirably from the top end of the longitudinally-extending flats 44 at the outer end of the radial holes 49 in the spindle 11.

The grease (shown by shaded areas in FIG. 2) is input into zerk 18 by a grease gun 75, and travels sequentially along the axial hole 47, out the radial holes 49, into and along the longitudinal flats 46, 50 (under the middle spacer 16), out the radial dispersion channels 65 into the bottom bearing 17. Thus grease is input into the system and fed directly thru a serial arrangement of interconnected narrow grease passageways into the bottom bearing 17, with positive and controlled distribution, and with minimal waste of grease and minimal consumption or “storage” of excess grease.

An alternative design may be used in applications where grease is preferably also forced upward into an upper bearing 15. In such case, the top spacer 14 or top end of the middle spacer 16 would have a collar and radial lubrication dispersion channels 65 extending towards that upper bearing 15 as well. This would allow grease to enter both bearings. For example, a bottom surface of the top spacer could be configured to have dispersion channels similar to the dispersion channels 65 in the bottom surface of the bottom collar on the middle spacer described above.

Benefits of this design over current designs include:
1. Grease is put specifically where needed.
2. There is an increased life of assembly.
3. There is a likely reduction of warranty costs.
4. Less grease is needed for regular maintenance (thus providing a more environmentally friendly circumstance due to lower exposure of grease to the environment and less cost).
5. Internal geometry of the housing can be designed for increase strength instead of being designed to allow gravity to move the grease to the lower bearing.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. An assembly comprising:
a spindle and a bearing spacer with a sleeve section surrounding a length portion of the spindle;
upper and lower bearings;
a housing including a cavity receiving the spindle with the upper and lower bearings supporting the spindle in the cavity; and
a narrow grease passageway extending from an end of the spindle to at least the lower bearing.

2. The assembly defined in claim 1, wherein the grease passageway includes at least one longitudinally-extending portion extending along the length portion and that is formed at least in part by one or both of the spindle and the bearing spacer.

3. The assembly defined in claim 1, wherein at least one section of the longitudinally-extending portion is formed between the spindle and the bearing spacer.

4. The assembly defined in claim 3, wherein at least one of the spindle and the bearing spacer define an open channel in the at least one section that is covered by the other of the spindle and the bearing spacer.

5. The assembly defined in claim 4, wherein the spindle includes an outer surface defining the open channel in the one section, and wherein the bearing spacer covers the open channel in the at least one longitudinally-extending portion.

6. The assembly defined in claim 1, wherein the spindle includes an axial grease-input hole and a radial hole extending from the grease-input hole to the longitudinally-extending portion.

7. The assembly defined in claim 1, wherein the bearing spacer includes a collar with at least one radial groove defining part of the grease passageway that extends from the longitudinally-extending portion to one of the bearings.

8. The assembly defined in claim 7, wherein the at least one radial hole extends though a shaft of the spindle.

9. The assembly defined in claim 1, wherein the spindle includes a shaft portion with an outer surface defining a circular cross section and wherein the longitudinally-extending portion includes a longitudinal surface formed into the circular cross section.

10. The assembly defined in claim 9 wherein the longitudinal surface includes at least one flat surface.

11. The assembly defined in claim 1, including a blade-shielding deck and a rotatable blade, the housing being attached to the deck by fasteners, the blade being attached to the spindle.

12. The assembly defined in claim 1, wherein the grease passageway includes a continuous grease passageway having a first portion formed by at least one hole in a top end of the spindle, a second portion of longitudinal passages formed by the longitudinally-extending portion, and a third portion formed by radial dispersion channels formed at least in part by a collar on the middle spacer and extending to the at least one bearing.

13. A spindle assembly having a length and adapted to convey grease along at least part of the length, comprising:
a spindle; and
a bearing spacer with a sleeve component surrounding a length portion of the spindle;
the spindle and the sleeve component combining to define opposing sides of at least one grease passageway extending a longitudinal distance along the spindle.

14. The spindle assembly defined in claim 13, wherein the spindle includes a flat surface forming one of the opposing sides.

15. A spindle assembly having a length and adapted to convey grease along at least part of the length, comprising:
a spindle having an axial hole in one end and at least one radial hole extending from an end of the axial hole to an outer surface of the spindle; and
a bearing spacer with a sleeve section surrounding a portion of the spindle; at least one of the spindle and the sleeve section defining at least one longitudinal grease passageway extending from the at least one radial hole and extending a distance along the spindle.

16. The spindle assembly defined in claim 15, wherein the bearing spacer includes a collar with second radial channels extending from the at least one longitudinal grease passageway to a bearing location.

17. The spindle assembly defined in claim 15, wherein the at least one longitudinally passageway extends at least 50% of a length of the spindle.

18. The spindle assembly defined in claim 15, wherein the at least one longitudinal grease passageway is formed at least in part between the spindle and the bearing spacer.

19. An assembly comprising:
a spindle;
at least a lower bearing;
a housing including a cavity receiving the spindle with the lower bearing supporting the spindle in the cavity; and
a grease-passageway-defining member on the spindle and in the cavity, the spindle including a top end with at least one hole extending to the grease-passageway-defining member, the spindle and the grease-passageway-defining member combining to define a continuous narrow passageway extending from the top end to the lower bearing for communicating grease directly thereto from the top end.

20. A method comprising steps of:
providing an assembly including a spindle, a bearing spacer with a sleeve section surrounding a length portion of the spindle, upper and lower bearings, and a housing having a cavity receiving the spindle with the upper and lower bearings supporting the spindle in the cavity; and
passing grease into a top end of the spindle, and then to at least one longitudinally-extending grease passageway formed at least in part by portions of the spindle and the bearing spacer, and then radially to the lower bearing.
